(19) United States
(12) Patent Application Publication
(10) Pub. No.: US 2013/0013328 A1
(43) Pub. Date: Jan. 10, 2013

(54) SYSTEMS, METHODS, AND DEVICES FOR AN ARCHITECTURE TO SUPPORT SECURE MASSIVELY SCALABLE APPLICATIONS HOSTED IN THE CLOUD AND SUPPORTED AND USER INTERFACES

(76) Inventors: John Jospeh Donovan, Hamilton, MA (US); Paul David Parisi, Boxford, MA (US); Svetlana I. Dotsenko, Beverly, MA (US)

(21) Appl. No.: 13/290,195

(22) Filed: Nov. 7, 2011

Related U.S. Application Data
(60) Provisional application No. 61/436,161, filed on Jan. 25, 2011.
(60) Provisional application No. 61/413,211, filed on Nov. 12, 2010.
(60) Provisional application No. 61/413,209, filed on Nov. 12, 2010.

(51) Int. Cl. G06Q 50/22; G06F 11/07; H04L 9/30; G06N 5/00; G06F 9/50

(52) U.S. Cl. 705/2; 706/45; 718/104; 713/168; 714/2; 714/E11.023

(57) ABSTRACT

The present invention describes an architecture for hosting and managing disparate, connected applications in a cloud environment. In addition to all of the traditional advantages of the cloud environment, e.g. the economies of renting vs. buying and scalability, this invention allows for management, security, data exchange, authentication, predictive performance and resource integrity it enables business opportunities and models that here-to-fore could not have been realized. Specifically an example being providing on a global scale an intelligent platform for managing a citizens health and health care, this patent covers the enabling technologies and the enabling business models and user interfaces.

### FIELD OF THE INVENTION

The invention may be applied to an architecture for the purpose of coordinating many data and application services which are electronically connected. For example, the invention may be applied to healthcare applications involving many independent applications, services, and data sources. The invention affords a high level of security for applications where data is sensitive as in the healthcare area. The invention handles applications that are meant to be used by a large number of users at the same time, and thus require scalability. The invention may be applied to applications where different processes have different workloads, and allows for efficient management of separate processes.

The invention takes into account latency metrics for existing applications and provides a method of giving users fast access to these applications and services.

The invention allows for securely spreading the workload from an application requiring extensive resources to multiple systems located in different geographical locations. The invention allows for securely spreading the workload of an application requiring minimal resources to multiple systems located in different geographical locations.

The invention may be applied as an architecture for a system where automatic allocation of computing resources to multiple applications and services is needed.

This invention allows for speeding up connections to services with high latency, and will also adapt to changing usage metrics of all services using the architecture in order to optimize speeds of all components. This invention allows for secure messaging to external sources that require the highest level of security. This invention allows for business models to support the ongoing viability of applications using this architecture. This architecture includes a mechanism by which correlation of metric and meta-data the intelligent platform dynamically can customize and optimize user experience.

### DEFINITIONS

Access Verification—A system for making sure the user or device accessing the system and the path taken by the user is appropriate and authorized for access.

Application—A computer program with a user interface designed to perform a task.

Architecture—The overall design or structure of an information system, including but not limited to the hardware, devices, network and the software required to run all applications in that environment.

Audit Engine—A system to examine and correlate audit events produced from devices connected to a system.

Authentication Correlation Engine—A system for the organization of Meta and non-Meta data about the participants in a computing system and or network.

Avatar—a computer based presentation of mechanical or human which can aid the user with contextualized verbal, textual or visual help.

Business Model—A business model is a quantitative justification for business use of an architecture. E.g. Return On Investment, Return On Assets and profitability.

Caching—A fast storage buffer for data.

Cloud—Generic compute resources hosted without regard to geographical proximity.

Correlated Events—A contextualized set of primitive and/or complex events creating information from the behaviors of devices and components involved in a system.

Global Virtual Hypervisor—A globally distributable control program enabling multiple processes to be correlated and share common or distributed computing systems.

Hypervisor—A control program enabling multiple operating systems to share a common computing system.

Intelligent Platform—A platform that enables the combining of data and processes in such a way that insights or conclusions are given that could not normally be formulated by looking at any individual data source.

Meta-data—A description of the data in a source, distinct from the actual data; for example, the prices listed in a catalog.

Predictive Caching—Proactive pre-population of a cache based on anticipated need.

Presentation Workflow Manager—The management system responsible for the presentation of the user interface of computer program

Primitive Events—The most basic transition of state within a system or between systems.

Process—A running software program or other computing operation. A part of a running software program or other computing operation.

Quality of Sustainability—This term means many different sources of revenues to support sustainability.

Reputation Database—A data store of Meta data about the relative merits, performance, utilization, integrity and identification of systems and components involved in network communications.

Sustainability—This term in this invention is applied to the businesses that use this architecture being able to sustain themselves via revenue from services via the platform.

Task Broker—A mechanism and system for assigning and managing work tasks and resources.

Trusted Data Exchange—A segregated set of systems which have a higher level of security and audit controls for accessing, federating and updating data from both internal and external systems.

Weights—The relative value of the information derived from the events observed as part of the system.

Work Load—A set of tasks to accomplish a result.

Work Load Manager—A mechanism and system for managing the groups of tasks (work load) which need to be done.

Worker Process—A component of a single or multiple threads in a processing unit logically constrained to a single processing unit.

### BACKGROUND OF THE INVENTION

In our global economy sets of needs of people requiring access to information and processes that are here-to-fore viewed as islands. Weather that be simply planning a trip or managing one's health needs. For example in managing one's health we have all experienced difficulties going from one provider to another, filling out the same information on forms over and over again, scheduling appointments, getting information and education, choosing an insurance company, simply finding out what you are insured for and much more provide us with an excellent demonstration of the need for technology and business processes needed to address these problems. Both the technologies and business processes are applicable to other industries as well.

A New Healthcare Environment Makes a Solution Possible, and Necessary and can be Implemented Only with this Invention:

The Federal government has invested $600 billion in Health Information Exchanges (HIEs) which create databases that consolidate regional patient data, and has created incentives to stimulate adoption of Electronic Medical Record (EMR) systems. The private sector has invested in on-line insurance systems, purchasing systems, on-line health education and hospital portals, etc. Healthcare costs currently represent over 17% of the United State GDP, and providers face a Federal mandate to reduce costs by 15% to 25% by 2014.

### The Problems

Virtually all current systems and repositories are islands, and healthcare costs continue to soar. Thus far, the technology is expensive and the architecture is complex. While stimulus funding is available for regions to build their HIE's, each HIE's sustainability will be based upon creating a business model which is independent of Federal funding. Hospitals, wellness centers and many other components of the health care ecosystem have separate uncoordinated data and processes.

### The Solution

For the first time, the technology, infrastructure, and organization techniques exist to create a platform to construct a comprehensive and easily accessible intelligent health management platform. The platform integrates information and applications from all healthcare stakeholders to create a virtual interconnected system, while protecting the privacy of all parties.

A business model, described here makes this possible. It includes e-commerce and revenue-sharing which will help sustain the non-for-profits and encourage the for-profits to join in on a national health information exchange platform.

### EXAMPLE APPLICATION

The rate of change of the knowledge base and techniques used in most skills, professions, and academic fields has accelerated.

For example, Requirements under Title IX of the Education Amendments of 1972 opened the floodgate for women participating in varsity sports at the level of men. Unfortunately, training girls in the same manner as boys are has led to a huge increase in sports related injuries for girls.

For example, in soccer, the rate of concussions among girls is 1.5 times the rate among boys (http://www.nytimes.com/2008/05/11/magazine/11Girls-t.html). Girls are also at a higher rate of risk in both roller-skating and gymnastics (http://www.childrenshospital.org/az/Site1112/mainpageS1112P0.html).

Simply put, better training at all levels, coaches, parents and athletes is needed.

The advent of new interactive technologies (including avatars and multimedia, etc.) has introduced an efficient way of reaching larger audiences, using fewer resources.

Further, if coaches have one level of expertise, systematically how do they reach additional levels of expertise and how do they take advantage of a wide range of available educational material.

In short, how does a person become CEO of his own educational progression within his sphere of interest?

This patent offers systems, processes and methods for solving these problems.

### BRIEF DESCRIPTION OF THE DRAWINGS

FIG. 1—Overall System Architecture indicating interactions of systems and data involved.

FIG. 2—illustrates the actors involved in determine predictive data gathering and caching.

FIG. 3—depicting overlapping areas of data with regard to constituent.

FIG. 4—Intelligent platform overview logical data sources and storage.

FIG. 5—login screen.

FIG. 6—registration Screens, Parts 1, 2 and 3.

FIG. 7—app store screen.

FIG. 8—my page (user) screen.

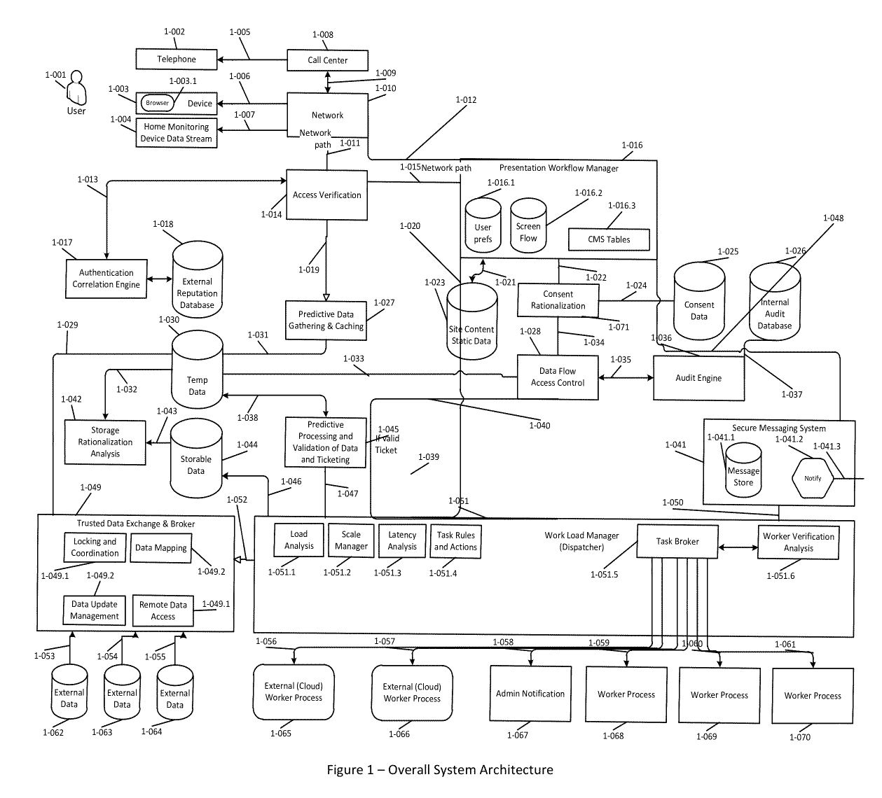

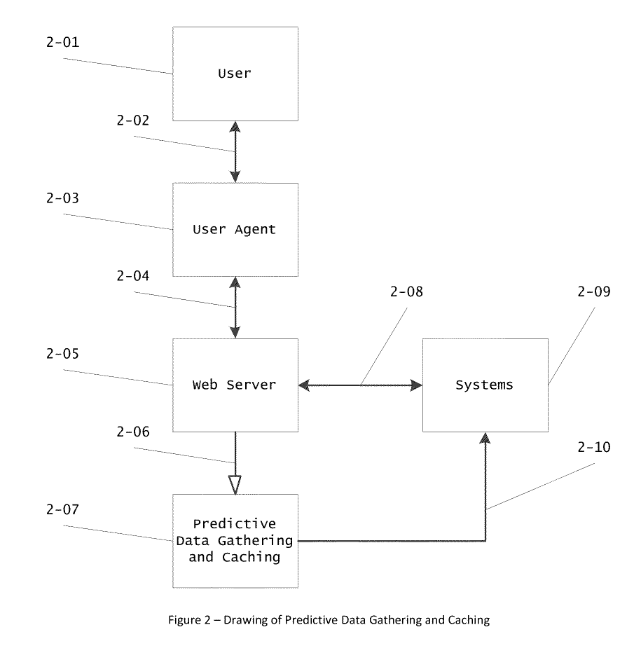

### DETAILED DESCRIPTION OF THE INVENTION

### Predictive Analysis and Data Gathering

The predictive analysis infrastructure allows for the observation of previously accessed data and for using those observations in the future when retrieving new data. These observations will be both on an identified level and on an abstracted and summarized level. A specific user will follow a certain pattern which will emerge and transform over time. Other users will also follow access patterns which will be aggregated and used to inform future trend analysis to anticipate and have the data ready before a user asks for it. Other metrics such as time of day, world events, other user behavior and many other Meta events will be used to inform the predictive engine. As soon as the system has a notion or anticipation that a user may be intending to access or connect to the system the predictive analysis and data gathering system gets as much data, based on prior use and potential anticipated use, as possible.

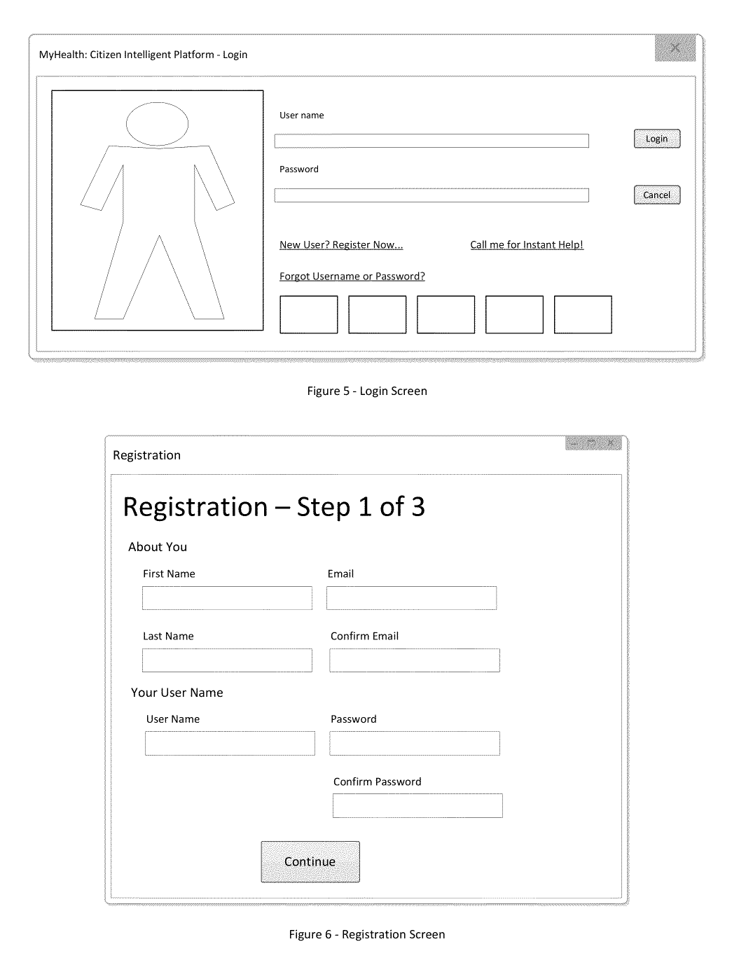

As a potential embodiment of this invention for a health related application as illustrated in FIGS. 5, 6, 7 and 8 we see that the user interaction supplies various data to the system, this data is used to predict which data may be useful to the user and begins the process of gathering that data.

A potential embodiment of this invention as illustrated in FIG. 5 we see that the user interaction with the avatar supplies various data to the system, this data is used to predict which data may be useful to the user and begins the process of gathering data to initialize the avatar's help knowledge and the data the user may require.

We can apply a mathematical model to prioritize predictive analysis, in order to determine which and how much data needs to be preloaded, and how far ahead in time it needs to be loaded into the system.

As a basis, we will use the formula for “Prefetch Scheduling Distance” where:

$$psd = \vert \frac{{N}_{latency} + {N}_{bandwidth} * ( {N}_{cache} + {N}_{st} )}{PE * {N}_{inst}} \vert$$

In this equation, N_{latency} is the latency of obtaining data from its source, N_{bandwidth} is the latency needed to process a unit of data, N_{pref} and Nₛₜ refer to the amount of data to cached and the amount of data to be stored, PE refers to the processing efficiency of the worker resource, and Nᵢₙₛₜ refers to the number amount of data that needs to be processed per iteration.

We have the same constants in this equation: Nₗₒₒₖᵤₚ, N_{xfer}, and PE. Nᵢₙₛₜ depends on the current process we are running. We need to calculate N_{cache} and Nₛₜ using values for psd.

To calculate psd, we use the following parameters: il for iteration latency, T_{c} for computation latency with caching, Tₗ is memory leadoff latency, and T_{b} for data transfer latency. In order to determine the proper psd, we need to follow the following steps:
Optimize T_{c} as much as possible
Use the following formulae to calculate psd:

T_{c}≧Tₗ+T_{b}

psd=1
il=T_{c}

Tₗ+T_{b}>T_{c}>T_{b}

psd=┌(Tₗ+T_{b})/T_{c}┐
il=T_{c}

T_{b}≧T_{c}

psd=1+┌Tₗ/T_{b}┐
il=T_{b}
Schedule the instructions using the computed psd

### Work Load Manager

Provides a shared context for managing, dispatching and assigning work to processes. The work load manager distributes the work that needs to be done to the task broker.

### Task Broker

Assigns tasks as they are ratified by the work load manager to processes. The task broker breaks down the task into accomplishable and scalable chunks and distributes them to waiting compute resources.

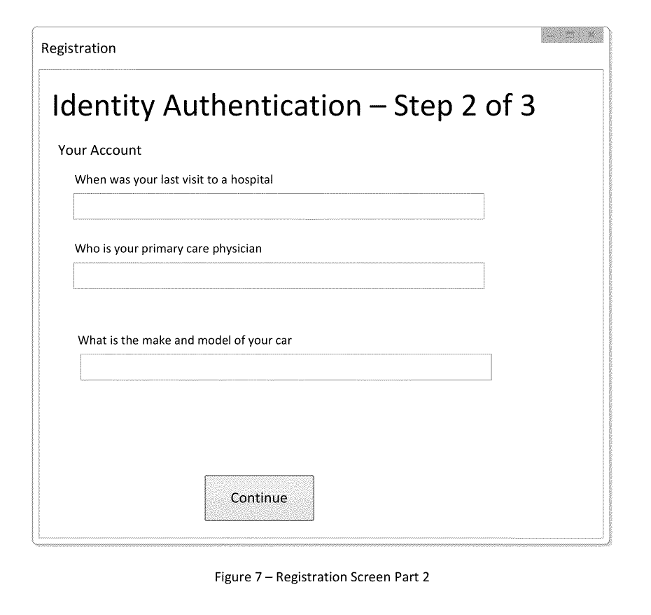

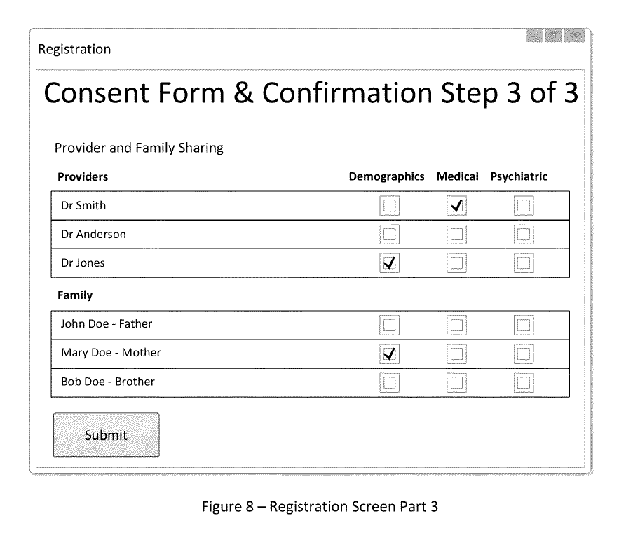

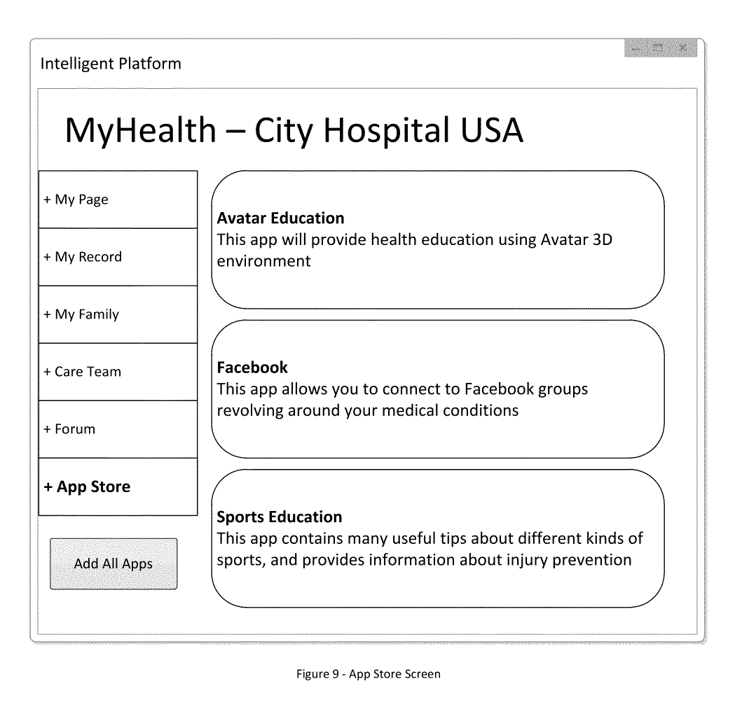

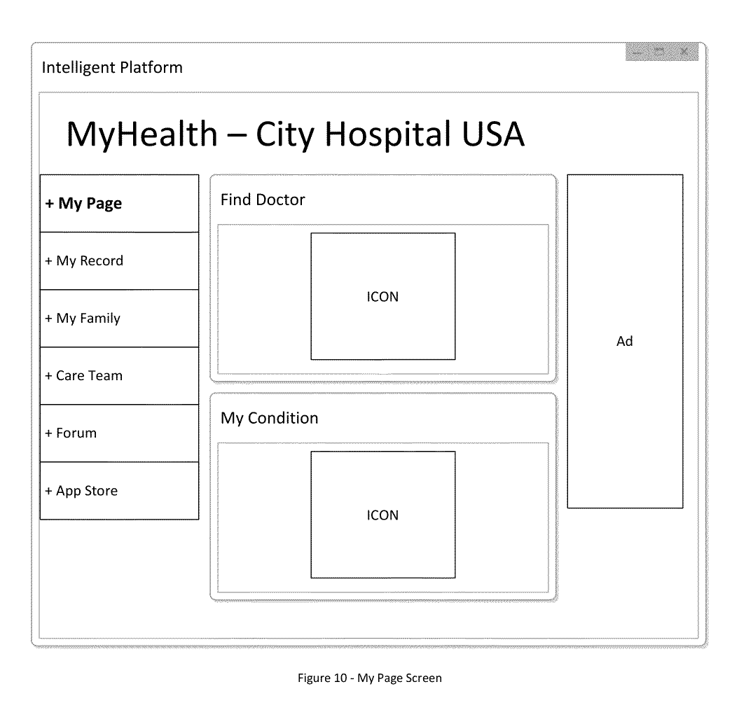

An embodiment of the present invention is the user interface described in FIGS. 7 and 8 which shows a presentation of available applications which are selected by a user and thus their choice implies to the system which data it may need to gather for the user which would then be broken down into subtasks and which the task broker would then assign as needed.

Assigning tasks to compute resources can be optimized in the following way:

Each process Pᵢ needs work Wᵢ to be performed. The time tᵢ it takes to perform the task can be estimated by dividing the work by the throughput of the resource assigned to perform the task Sᵢ:

$${t}_{i} = \frac{{W}_{i}}{{S}_{i}}$$

Thus work that needs to be performed is a function of time. However, it is not linear in time, as Sᵢ can change as a function of time, as we switch the process to a different resource, or as the nature of the process changes making Sᵢ more suitable to run the task:

Sᵢ=F(t)

[symbol]

Wᵢ=tᵢF(t)≡G(t)

We can take the first derivative of this function in order to know whether the amount of work required by this process is increasing or decreasing, and a decision can be made about which of the resources to assign the resource to:

$$\frac{\partial {W}_{i}}{\partial t} = \frac{\partial F ( t )}{\partial t}$$

This derivative will tell us whether the process is increasing or decreasing demand for resources, and thus provide us with information about assigning more or less resources toward its execution.

### Worker Verification

As compute resources become available they securely register themselves with the platform. Each compute resource which will handle processes is continually audited from a code fingerprint point of view, network context, performance, activity, progress and responsiveness.

### Scale Manager

The scale manager observes the responsiveness, throughput and utilization of the currently running compute resources. The scale manager can provision and de-provision resources predictively based on current use and trends contextualized over time. For example, usage might be lower late at night and thus resources would be de-provisioned.

### Load Analysis Manager

The load analysis manager is responsible for contextualizing load metrics as reported by compute resources as they process work.

### Latency Analysis Manager

The latency analysis manager is responsible for observing the amount of time a computer resource requires to perform a task and to the time required to respond to network queries and informing the bus other management systems that too much time may have passed (i.e. the compute resource has gone away or become stuck) and the task needs to be reassigned. These observations will be recorded over time to allow for future predictive analysis.

We will use the latency analysis manager to calculate and store the following constants to be used in the calculation of psd: N_{latency} and N_{bandwidth}.

### Tasks Rules and Actions Manager

Tasks are sets of actions constrained by an ordered set of rules. I.e. the instructions for the processing that needs to occur. These rules and actions are stored in a database so they can easily be packaged and handed to a process for work to be done.

We will use the task rules and actions manager to keep track of the PE and Nᵢₙₛₜ to be used in the calculation of psd.

We will also store the set of rules R which govern assigning tasks to processes in this manager, and we will use the combination of the rules in order to determine the work assignments.

### Internal Ticketing System and Manager

An internal inter-process messaging and ticketing system which encompasses a mutual authentication system to securely authenticate all participants in the communications. For example the artifact of the completion of a work process would be the generation of a ticket. Tickets intrinsically have attributes of time of creation, validity, encryption and security. It is the primary mechanism and messaging wrapper for notification within the platform. We can define T as

T=T(Tₜ,Tᵥ,Tₑ, . . . , Tₙ)

Where Tₜ is the time of creation, Tᵥ is the validity, Tₑ is the encryption, and Tₙ denotes the nth attribute assigned to a ticket.

### Trusted Data Exchange and Broker

All external data communication is done in a confined security realm. Data is retrieved and distributed by processes running within this realm. Notification of “data ready” can propagate out of the realm using the internal ticketing system. Data used for processing is pushed to a trusted area for temporary storage outside of the Trusted Data Exchange allowing lower security process a means for access. Sub components of the Trusted Data Exchange and Broker include:
Locking and coordination for data commit/de-commit management.
Data mapping for dynamic schema assimilation and translation.
Data update management to allow for intelligent updating of outside databases.
Custom remote data access middleware to allow for access to and transformation of remote data connections.

### Storage Rationalization

The storage rationalization system takes data in temporary storage that is allowed to be stored for future use and or analysis and moves it to a long term data warehouse. Certain data is not allowed to be stored and thus, this system makes sure that data is not stored.

### Consent Rationalization

Constituents of the system have certain data access privileges given and taken away over time and based on the types of data contained in the system. Users can control which users can see what data based on a variety of dimensions. These dimensions need not be predefined. The consent rationalization system takes these dimensions and produces dynamic access control rules based on the user requesting access to the data at the time of access. Thus some users (or processes) will be blocked, as appropriate, from accessing restricted data. A potential embodiment of the consent representations to the user is displayed in FIG. 6.

Additionally we incorporate an option for a “set of conditions” which can explicitly override access controls as would be normally rationalized. For example, in health care, if a patient presents at an emergency room, valid providers can instantiate a “need-to-know” condition and if the patient has beforehand allowed for this type of override consent the provider can access the data for a predefined length of time and to a certain depth. Further, the access can be organized into hurdles which can have escalating levels of necessity to allow for an override. This comprises an ability to manage access to information on a “need-to-know” basis.

We can express consent as a function of the conditions that constitute consent:

C=I{C₁=1}I{C₂=1} . . . I{Cₙ=1}

Where Cᵢ is a condition for consent and I is the indicator function. Thus if any of the Cᵢ return 0, then consent is overridden and not granted.

### Access Verification

Access Verification uses the technology described in provisional patent application No. 61/413,190 entitled SYSTEMS, METHODS AND DEVICES FOR PROVIDING DEVICE AUTHENTICATION, MITIGATION AND RISK ANALYSIS IN THE INTERNET AND CLOUD.

An embodiment of the present invention includes the displays described in FIGS. 5 and 6 which create events and gathers data via the user's interaction with the system and triggers processes such as access verification.

### Recovery in a Cloud Environment

When a compute resource notifies the task broker that it is available for a task the task broker records a relationship with that resource. The resource continues to notify the task broker via a predicated polling interval as to its performance, current activities, progress and expected completion. If the task broker does not receive an update poll with reasonable parameters within a reasonable timeframe and within the predicated polling interval (as agreed at instantiation) the task broker can take action such as reassignment of the task to another compute resource. Further the task broker assimilates this Meta data over time and uses it to develop opinions about the veracity and reliability of the compute resource. These data are recorded and used for future prediction of resource usefulness and then used for subsequent assignment. This exchange of information is done in a secure encrypted manner. Weights are associated with the metadata and the combination of these weights is used along with a threshold to determine reassignment.

Equations 1, 2, and 3 show possible rules that may be evaluated by the correlation process. For example, as shown in Equation 1, action component A₁ will be activated if the expression within the indicator function is greater than some predetermined threshold τ₁. In Equations 1, 2, and 3, the Aₖ denote actions, the xᵢ denote non-medical events, the mⱼ denote medical events, and the wᵢ and wⱼ denote attribute weightings for non-medical data and medical data respectively (note: the wᵢ are themselves variables which may historically change as the trust factor is recorded and recognized). Equations 1, 2, and 3 might represent a hierarchy of actions that would be activated for different threshold scenarios. Equations 1, 2, and 3 are illustrative of only one embodiment of the present invention, and the present invention may be implemented using other equations and other expressions.

$$\begin{matrix}{A}_{1} = I \{ {\sum }_{i} {w}_{i} {x}_{i} + {\sum }_{j} {w}_{j} {x}_{j} \geq {τ}_{1} \} & ( 1 ) \\ {A}_{2} = I \{ {\sum }_{i} {w}_{i} {x}_{i} + {\sum }_{j} {w}_{j} {x}_{j} \geq {τ}_{1} \} \\ ⋮ & ( 2 ) \\ {A}_{n} = I \{ {\sum }_{i} {w}_{i} {x}_{i} + {\sum }_{j} {w}_{j} {x}_{j} \geq {τ}_{n} \} & ( 3 )\end{matrix}$$

Equation 4 shows an example of a calculation for determining weights. The weights “wᵢ” may be a weighted average of attribute data (aᵢ), including resolution of the situational medical data (R, “Src_AW_Quality”), age of the data used to capture the situational medical data (A, “Src_AW_Age”), time since last instance of the situational medical data (TM, “Src_AW_Currency”), and reliability of the source of the situational medical data (RS, “Src_AW_Reliability”). Note that a similar expression can be used to calculate the importance (Y) of data by the device authentication module when determining when to validate a device. Other weighting factors may also be used, and the weighing factors described here are illustrative only and are not intended to limit the scope of the invention.

$${w}_{i} = {\sum }_{k} {ω}_{k} {a}_{k} \qquad ( 4 )$$

In equation 4, the ωₖ are relative weights of the attributes aₖ, which are themselves weights associated with the data sources. The preceding equations are illustrative of but one manner in which the present invention may be implemented and are not intended to limit the scope to only these expressions.

The variance of the weight over time can be described with the following Equation 5, where W is the final weight attributed to a component, k indexes the instances of time when weights were collected, tₖ refers to the actual time when the kth weight was collected (starting at a reference point of 0 for the present time), and C refers to a cutoff specific to the device. Note that this weight is exponential in r, which is a function of tₖ; fractions most close to the present time get the highest weight and depending on the component, a cutoff may occur:

$$\begin{matrix}W = \frac{1}{T} {\sum }_{k = 0}^{T} τ {e}^{τ} {ω}_{k} & ( 5 ) \\ τ = \{ \begin{matrix}0 , & C - {t}_{k} \leq 0 \\ x , & x > 0\end{matrix} & ( 6 )\end{matrix}$$

### Management of Version Control in a Cloud Environment

When a compute resource registers its availability with the task broker Meta data is exchanged as to the capabilities and versions of resources available to the compute resource. This informs the task broker and task manager as to what the capabilities of the compute resource are. The task broker may instruct the computer resource to retrieve new code or components to expand or change its present capabilities. This exchange of information is done in a secure encrypted manner.

Every resource, including software (Si) and hardware (Hn), has associated with it a version, capabilities, and use. This metadata is made available to the task broker in order to identify its best possible use, or to identify the need to upgrade. The task broker has a process for matching every resource with a task given the resource's metadata:

F(resource)=Best Match(Si∩Hn)

### Business Models Supported by the Invention

Applications here-to-fore not being able to be scaled are now possible. Hence new revenue generation possibilities now exist. One embodiment of a new business model encompasses HIE's which receive medical data from hospitals and have received government funding to build data repositories but not sustained funding. Application of this invention creates a platform for revenue sharing for HIE's. These opportunities include: e-commerce, education, clinical trials, medications and more.

One embodiment of a new business model encompasses hospitals. Application of this invention creates a platform for revenue sharing for hospitals by facilitating integration of ecommerce and services functionality into the hospital's websites. These would include: insurance selection, medication management, family access of health information, education and more.

One embodiment of a new business model encompasses the insurance industry. Application of this invention creates a platform for revenue sharing for the insurance industry resulting from analysis of fraud, insurance selection, insurance optimization, family review and access to policy information, cost of care analysis and what-if scenario analysis and more.

One embodiment of a new business model encompasses the pharmaceutical industry. Application of this invention creates a platform for the timely and accurate enablement of drug or device recall; allow expedient contact with consumers and providers of such devices or drugs using claim and other data gathered from connected systems.

One embodiment of a new business model encompasses education. Application of this invention creates a platform for the communication of educational content to consumers and providers that is available from many different sources and formats including textual, video, interactive avatar and others.

One embodiment of a new business model encompasses wellness initiatives. Application of this invention creates a platform for the real-time and non-real-time gathering of health details to help maintain wellness.

One embodiment of a new business model encompasses the pharmaceutical industry and medical device companies. Application of this invention creates a platform for identification of patients and correlation of patient data to help select appropriate people for appropriate trials.

The business model for all of the above embodiments could be either revenue sharing or a per transaction fee. These fees could be assessed at the task broker, task manager, auditing, presentation workflow manager, access verification, authentication correlation engine, predictive data gathering and caching, consent rationalization, data flow access control, audit engine, secure messaging system, storage rationalization analysis, ticketing system and others.

### BRIEF DESCRIPTION OF THE DRAWINGS

### Architecture Diagram

### Drawing of Predictive Data Gathering and Caching

Overlap of constituent data
Intelligent platform overview logical data sources and storage
Login Screen—The login screen provides the ability for a user to enter their username and password. The user can also elect to change the language of the display. The user can request additional information such as details about the privacy policy and other site related information. This information is displayable in text, video and/or interactive avatar. The user can also choose to register should they not already have an account.
Registration Screen—The registration process is a series of several screens; each subsequent screen asks for more information or allows the user to defer those questions till a later time. Each request for more information allows the platform to better identify the authenticity of the user accessing the system. This is done via a series of challenge/response queries relating to data only the actual person would know.
App Store—The user can browse available applications and add them to their personalized web page. These applications can be filtered and searched based on the information the platform knows about the user. The user can change the filtering and searching as desired. At any time new applications can be added and the user can choose to add them to their page. Applications can be updated to new functionality via the backend systems.
My Page—This is the user home page within the system. The user can select and add their own apps to this page. The user can also easily access their frequently used functions from this page.

### DETAILED DESCRIPTION

The present invention is described with reference to the drawings, wherein like reference numerals are user to refer to like elements throughout.

A user (1-001) uses a device (1-003) encompassing a browser (1-003.1) and connects to web server (1-016) or similar system via a network (1-014) via network paths (1-006, 1-011, 1-012), portions of which may be comprised of paths which transit the internet. Upon connection to the web site (1-016) the user is presented with the initial web site pages generated from a combination of data from (1-016.1, 1-016.2, 1-016.3 and 1-023 via 1-021). Simultaneously, upon connection to the web site (1-016), the connections are observed and data is passed via 1-015 to the Access Verification module (1-014). The Access Verification module executes tests to observe and understand the devices, networks and path transited (1-003, 1-003.1, 1-006, 2.010 and 1-012) by the user (1-001). The Access Verification module (1-014) stores and accesses data in a database (1-018) of previously recorded and assessed data correlated to reputation and the typical natural flows of data over the networks via a mechanism of the Authentication Correlation Engine (1-017) via a path (1-013).

Simultaneous with these events, as the user (1-001) is identified by the system through any of several mechanisms such as password and/or other means, that identification is passed via an event (1-019) to the Predictive Data Gathering and Caching module (1-027). In turn, the Predictive Data Gathering and Caching module instantiates processes to retrieve data relevant to the expected user. The Predictive Data Gathering and Caching module utilizes aspects of the Work Load Manager (1-051), and its constituents, the Trusted Data Exchange & Broker (1-049) and stores data into a temporary database (1-030) for ready access by the user should they arrive and request it. As the Predictive Data Gathering and Caching module (1-027) retrieves data events are transmitted to the Predictive Processing and Validation of Data and Ticketing module (1-045) which creates a state table of tickets for the data available for use by the systems. The systems will consume this data if needed via mechanisms provided by the Data Flow Access Control module (1-028) and the Work Load Manager (1-051).

Asymmetrically with this event and processing the Storage Rationalization Analysis (1-042) module reviews the data stored in the temporary database (1-030) and copies data which is allowed to be stored for the long term into a Storable Data database (1-044).

Once the user (1-001) is authenticated to the system a customized web user interface is presented. This is prepared and sent to the user's browser by the Presentation Workflow Manager (1-016) from the information available in the User Prefs (1-016.1), Screen Flow (1-016.2) and CMS Tables (1-016.3) databases. The user (1-001) chooses a function and then the system examines the requested function and prepares to return that data to the user (1-001). The requested function may require analysis of the user's rights to access such data, if such classifications are in place a Consent Rationalization (1-071) process is begun which interacts with the Consent Data database (1-025) via a private connection (1-024) and determines if the data is allowed to be accessible by the user. If the user is allowed to access the requested data the Data Flow Access Control (1-028) uses the data in the Temp Data database (1-030) if it is available, if the data is not available the Data Flow Access Control (1-028) module interacts with the Work Load Manager (1-051) modules and propagates retrieval requests as necessary utilizing the Trusted Data Exchange & Broker (1-049) modules.

Asymmetrically all systems and modules supply audit information to a dedicated Audit Engine (1-036). This audit information is stored in an Internal Audit database (1-026) via a private connection (1-037). Connection (1-035) is a typical example of audit data transiting within the system or between components of the system.

Non-presence based user messaging is provided by a local (logically to the system) Message Store database (1-041.1). Users are able to interact with the messages stored and create new messages via the Presentation Workflow Manager (1-016) via a connection (1-048) to the Secure Messaging System (1-041). Users and participants in the message are notified that a message is available for review by a notification via 1-041.2 and 1-041.3. Notifications are executed by using standard methods and protocols to propagate the notification via existing mechanisms such as email, SMS messaging or voice call and others. This methodology circumvents the implicitly lower security of traditional store and forward systems (email) as the message is never transited to foreign systems for forwarding.

This present invention allow for mechanisms for semantically recasting data at its source or at an interim point for adaptive reconciliation allowing patterns and matches to be easily observed using data from user behavior, user-system interaction, systems interaction, patterns of use, network transit points, network device processing, stored data, data retrieval patterns, meta data on such, geography, and contextualized behavior observable via meta data analysis.

An embodiment of the present invention is a system which provides for method for a medical device manufacturer to query the data and retrieve Meta data about that data with retrieving the data. For example data stored on previous orders of medical equipment related to diabetes, and a separate system where test strips had been ordered and a separate system where medical education was accessed having to do with diabetes. Reconciliation of the entity having the nexus of such information can be accomplished by this technique and this architecture supports such applications.

What is claimed is:

1. To substantially reduce response time, we will use predictive analysis at the application level.

2. To substantially reduce response time, we will dynamically assign processes to available resources.

3. To substantially reduce response time, we will intelligently cache data that can be cached, noting different classes of data and cache policies, e.g. health records, cannot be cached.

4. To protect privacy and enable sharing of health records, we have developed a consent mechanism.

5. To assure secure messaging, we have introduced a notification process that is more secure than traditional methods.

6. A mechanism for securing applications and data as it is processed through different stages and portions of the platform, using dynamically generated private keys.

7. Multiple virtual hypervisors, managing computation at the process level, sharing a common encrypted communications realm for coordinating all activities on all elements and services of the platform.

8. A reputation database of process efficiency that allows scalability and increased response time of processes based on assignment of resources to processes.

9. A computational correlation recovery mechanism for any component failure in the cloud.

10. A method for rationalization of managing version control throughout the cloud.

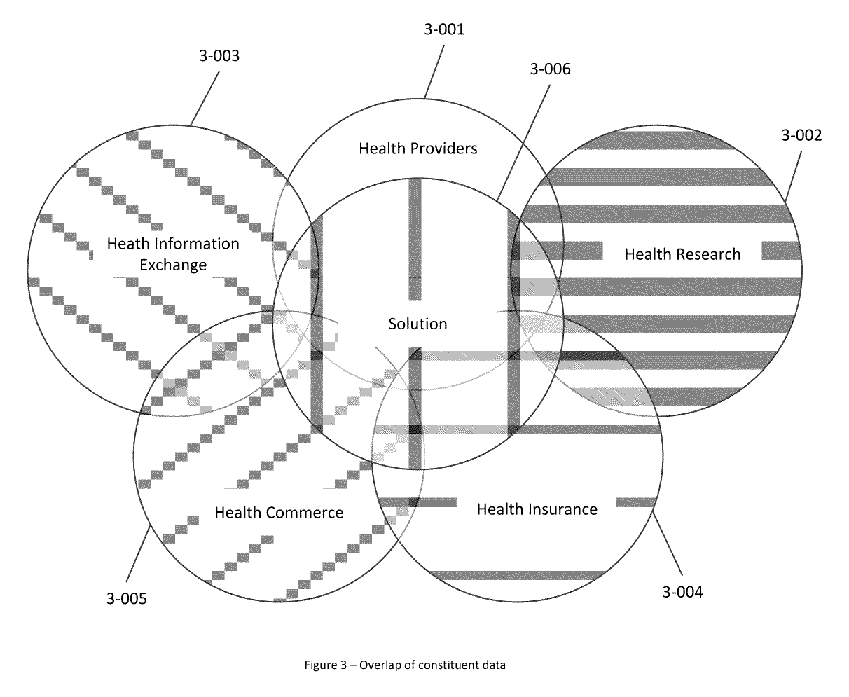

11. This architecture enables business applications and business models that here-to-fore could not have been implemented. An example being an intelligent platform for managing a persons health needs. That is personalizing all the services that a person needs including but not limited to education, e-commerce, medical records, insurance, providers, etc. See FIG. 3.

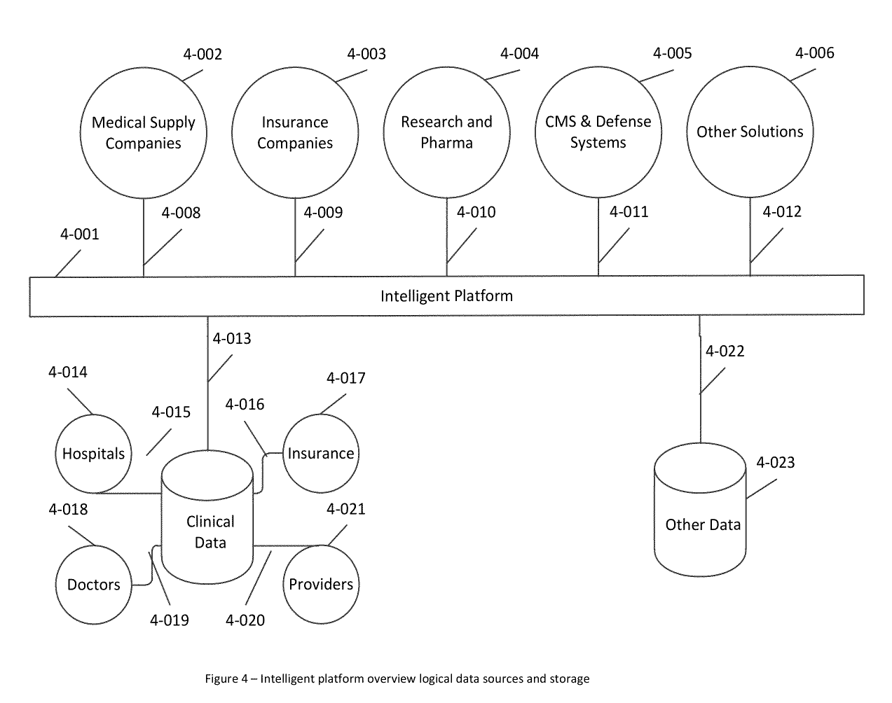

12. A business model for services on the internet that does not depend solely on advertising revenue such as Facebook, Yahoo and others. Where the business model derives revenue from a large variety of services to various user sectors including (See FIG. 4):
consumers of healthcare,
physicians and providers, including hospitals and long-term facilities,
Insurance providers, including Medicaid and Medicare.
Suppliers, including pharmacies, laboratories, general purchasing organizations, and medical device suppliers.
Advisors, including health education and financial planning.
Audit medication interaction across providers.
Reduce costs by mitigating fraud e.g. matching claims to medical records.
Manage healthcare financial planning.

13. This allows for typically non self-sustaining organizations, such as HIE's, to share in these revenues and thus become sustainable.

14. The architecture allows for transaction fees assessed at various levels of processing.

15. Personalizing content to a user based on correlating not only browser information, but other information such as but not limited to medical records, buying habits, ecommerce data, demographic data, reputation data, educational queries, insurance coverage, location, environment, employment, family history, etc.

16. Can target best choices, for example insurance based on medical records, buying habits, ecommerce data, demographic data, reputation data, educational queries, insurance coverage, location, environment, employment, family history, etc.

17. Alerting users to possible buying opportunities, educational opportunities, health dangers, potential security violations, privacy violations.

18. The system allows for audit trails and analysis of all user interactions.

19. All of this has been enabled by this architecture on a scale of hundreds of millions of users and services.

20. A set of user screens to facilitate the functionality including specifying consent, authentication, dynamically constructing applications customized to the user.

21. The user behavior and interaction with the user interface and correlating those with the current context of such interaction.

22. Semantically recasting data at its source or at an interim point for adaptive reconciliation allowing patterns and matches to be easily observed using data from user behavior, user-system interaction, systems interaction, patterns of use, network transit points, network device processing, stored data, data retrieval patterns, meta data on such, geography, and contextualized behavior observable via meta data analysis.
